(19) United States
(12) Patent Application Publication
(10) Pub. No.: US 2020/0167740 A1
(43) Pub. Date: May 28, 2020

(54) SYSTEM AND METHOD FOR TRANSITIONING A BLOCKCHAIN BETWEEN DIFFERENT STATES

(71) Applicant: Keir Finlow-Bates, Kangasala (FI)

(72) Inventor: Keir Finlow-Bates, Kangasala (FI)

(21) Appl. No.: 16/199,235

(22) Filed: Nov. 26, 2018

(51) Int. Cl. G06Q 20/06; G06Q 20/38; G06F 16/182; H04L 9/06; H04L 9/08; H04L 9/32

(52) U.S. Cl. CPC G06Q 20/065; G06Q 20/3829; G06F 16/1824; G06F 16/1834; H04L 12/4641; H04L 9/0825; H04L 9/3297; H04L 2209/38; H04L 2209/56; H04L 9/0643

(57) ABSTRACT

A system and method for transitioning a blockchain between an open state and a permissioned state, or a public state and a private state, is disclosed. The blockchain is initiated in one state and is transitioned to another state after a transition proposal is sufficiently endorsed. If the blockchain is in the permissioned state or the private state, transition may be triggered by consensus between a number of blockchain administrators. If the blockchain is in the open state, transition may be triggered by vote or endorsement. If the blockchain is in the public state, the transition proposal may comprise virtual private networking credentials. In some embodiments a right to endorse the transition proposal may correspond with an ownership or expenditure of an amount of cryptocurrency.

### TECHNICAL FIELD

This disclosure relates to computer systems and methods concerned with permissions relating to a blockchain or a distributed ledger, and more specifically to altering the permissions of the blockchain or the distributed ledger over time.

### BACKGROUND

Distributed ledgers or blockchains provided in, for example, a peer-to-peer network such as the distributed ledger used in the Bitcoin cryptocurrency system, may be open blockchains. An open blockchain may allow any user to join and participate in submitting transactions to the open blockchain and in adding data blocks (known as “mining”) to the open blockchain.

A permissioned blockchain, on the other hand, may have restrictions imposed on some or most of the users. A user may hold administrator rights for the permissioned blockchain, and may mine blocks, submit transactions, and grant or revoke such permissions to other users. Other users may only have limited permissions on the blockchain, for example they may only be able to read content on the blockchain or submit transactions, but not mine blocks.

The open blockchain may have advantages over the permissioned blockchain, in that the open blockchain may be more able to attract a large community of users through incentives that may be offered, such as awarding cryptocurrency to users who devote computing resource to securing the open blockchain network by running a proof of work or other consensus protocol. The open blockchain may also offer anonymity or pseudo-anonymity for users.

The permissioned blockchain may have advantages over the open blockchain, in that the permissioned blockchain does not require an energy intensive consensus system such as proof of work to secure the permissioned blockchain, and in that administrators may be able to exercise more control over an operation of the permissioned blockchain.

At different times it may be more desirable to have the advantages of one type of blockchain, and at other times it may be more desirable to have the advantages of an other type of blockchain.

Other terms used to describe blockchains include a public blockchain, wherein any participant on the Internet may view content of the public blockchain and the public blockchain is therefore visible to the public. In contrast, a private blockchain is instantiated on a private network such as a virtual private network (VPN) and may not be visible to the public in general.

It is therefore an intention of the present disclosure to address the problem of enabling a blockchain system to possess properties or either open blockchains or permissioned blockchains, and/or either public blockchains or private blockchains, by presenting a solution for transitioning a blockchain between a state of being open or being permissioned, and/or between a state of being public or private.

### SUMMARY

In accordance with the present disclosure, a solution is provided for transitioning a blockchain between a state of being open or a state of being permissioned, and similarly a solution is presented for transitioning a blockchain between a state of being private and a state of being public.

Blockchain validators, comprising, in a preferred embodiment of the present disclosure, a plurality of network connected devices participating in maintaining and extending the blockchain, may receive data and messages over a peer-to-peer network, which they may regularly package into a data block for potential inclusion in the blockchain. The data block may comprise messages instructing participants on the blockchain to take one or more specific actions. Messages are referred to in the present disclosure as “messages” if they provide information (which may subsequently prompt an action), and “transactions” if they provide a report of a change. If the validators deem a message or transaction to be valid, that is, it complies with protocols and rules of the blockchain, the validators may add the message or transaction to the blockchain by including it in the data block.

In an embodiment of the present disclosure, a blockchain may be transitioned from a permissioned state to an open state by an administrator: publishing a proposal on the blockchain to transition the blockchain from the permissioned state to the open state; publishing on the blockchain, by zero or more further administrators, an endorsement of the proposal; and when a predetermined number of endorsements have been published, transitioning the blockchain from the permissioned state to the open state.

In the embodiment the predetermined number may comprise a fraction of a total number of administrators on the blockchain. For example, if ten administrators are participating on the blockchain, the predetermined number may comprise a half, and four or more administrators may be required to publish endorsements of the proposal for the proposal to be acted on, with the administrator publishing the proposal automatically counting as an endorser.

In the embodiment the proposal may comprise a selection of a consensus system for the open state. The consensus system may, in some embodiments, comprise one or more of: a proof of work, a proof of stake, a delegated proof of stake, a proof of importance, and/or a proof of authority.

In the embodiment the proposal may comprise a proposed block height at which the transition occurs, provided a sufficient number of administrators have endorsed the proposal.

In the embodiment, participants on the blockchain may reject any blocks submitted to the blockchain that do not comply with the consensus system after the proposed block height is reached and if the proposal is accepted.

In a second embodiment of the present disclosure, a blockchain may be transitioned from an open state to a permissioned state by: a user of the blockchain publishing a proposal on the blockchain to transition the blockchain from the open state to the permissioned state; zero or more further participants publishing endorsements of the proposal on the blockchain; and when a predetermined number of endorsements have been published, transitioning the blockchain from the open state to the permissioned state.

In the second embodiment the proposal and/or the endorsements may each comprise a transaction of one or more of: a cryptocurrency burning, evidence of ownership of a quantity of cryptocurrency, a cryptocurrency locking transaction, and/or a cryptocurrency transfer transaction.

In the second embodiment the proposal may comprise a proposed block height at which the transition is proposed to occur.

In the second embodiment the user of the blockchain and/or each of the zero or more further participants on the blockchain publishing endorsements may each be granted administrator rights if an amount of cryptocurrency referenced in each transaction is above a predetermined amount.

In the second embodiment administrator rights may comprise one or more of: a right to publish transactions, a right to receive transactions, a right to mine data blocks, and/or a right to grant administrator rights to other participants.

In the second embodiment, once the blockchain has transitioned from the open state to the permissioned state, participants without administrator rights may be prohibited from one or more of: publishing transactions, receiving transactions, mining data blocks, and/or granting administrator rights to other participants.

In a third embodiment of the present disclosure, a plurality of network connected devices, each possessing administrator rights on a blockchain and comprising: one or more processors and storage media comprising computer instructions, said plurality of network connected devices being connected via a peer-to-peer network to each other, may be arranged such that, when the computer instructions are executed on the one or more processors of one or more of the plurality of network connected devices, operations are caused for a transition of the blockchain from a permissioned state to an open state, said operations comprising: publishing, by a first of the plurality of network connected devices, a proposal on the blockchain to transition the blockchain from the permissioned state to the open state; publishing, by zero or more of a remainder of the plurality of network connected devices, an endorsement of the proposal; and, when a predetermined number of endorsements have been published by the remainder of the plurality of network connected devices, transitioning the blockchain from the permissioned state to the open state by the plurality of network connected devices.

In the third embodiment, the predetermined number may comprise a fraction of a total number of the plurality of network connected devices. For example, in a network with ten network connected devices the fraction may comprise a half, and as a result four endorsements by four network connected devices may need to be published for a transition of the blockchain from the permissioned state to the open state to occur, with the first network connected device counting as a fifth endorser by virtue of publishing the proposal.

In the third embodiment, the proposal may comprise a selection of a consensus system for the open state. The consensus system may comprise one or more of: a proof of work, a proof of stake, a delegated proof of stake, a proof of importance, and/or a proof of authority.

In the third embodiment, the proposal may comprise a proposed block height at which the transition is proposed to occur.

In the third embodiment, any blocks submitted to the blockchain that do not comply with the consensus system after the proposed block height is reached and the proposal is endorsed, may be rejected by the plurality of network connected devices.

In a fourth embodiment of the present disclosure, a plurality of network connected devices participating on a blockchain, each comprising: one or more processors and storage media comprising computer instructions, said plurality of network connected devices being connected via a peer-to-peer network to each other, may be arranged such that, when the computer instructions are executed on the one or more processors of one or more of the plurality of network connected devices, operations may be caused for a transition of the blockchain from an open state to a permissioned state, comprising: publishing, by a first of the plurality of network connected devices, a proposal on the blockchain to transition the blockchain from the open state to the permissioned state; publishing on the blockchain, by zero or more of a remainder of the plurality of network connected devices, an endorsement of the proposal; and, when a predetermined number of endorsements have been published, transitioning the blockchain from the open state to the permissioned state by the plurality of network connected devices.

In the fourth embodiment, the proposal and/or the endorsement may comprise a transaction of one or more of: a cryptocurrency burning, evidence of ownership of a quantity of cryptocurrency, a cryptocurrency locking transaction, and/or a cryptocurrency transfer transaction.

In the fourth embodiment, the proposal may comprise a proposed block height at which transitioning is proposed to occur.

In the fourth embodiment, for each one of the first of the network connected devices and the zero or more of the remainder of plurality of network connected devices, administrator rights may be granted once the blockchain is in a permissioned state, if an amount of cryptocurrency referenced in the proposal and respective transactions submitted are above a predetermined amount. Through this, each participant on the blockchain may have an opportunity to buy administrator rights through a cryptocurrency transaction.

In the fourth embodiment, administrator rights may comprise one or more of: a right to publish transactions, a right to receive transactions, a right to mine data blocks, and/or a right to grant administrator rights to other participants. In other embodiments, rights may further comprise: a right to issue or reissue digital assets, a right to publish smart contract code, a right to execute smart contract code, and a right to issue or publish proposals.

In the fourth embodiment, once the blockchain is in a permissioned state, network connected devices without administrator rights may be prohibited from one or more of: publishing transactions, receiving transactions, mining data blocks, and/or granting administrator rights to other participants.

In a fifth embodiment of the present disclosure, a blockchain may be transitioned from a private state to a public state by: a user publishing a proposal on the blockchain to transition the blockchain from the private state to the public state; publishing on the blockchain, by zero or more further users, an endorsement of the proposal; and when a predetermined number of endorsements have been published, transitioning the blockchain from the private state to the public state.

In the fifth embodiment the predetermined number may comprise a fraction of a total number of users on the blockchain. For example, if ten users are participating on the blockchain, the predetermined number may comprise a half, and four more users may be required to publish endorsements of the proposal for the proposal to be acted on, with the proposer counting automatically as a fifth endorser.

In the fifth embodiment the proposal may comprise a proposed block height at which the transition occurs, provided a sufficient number of users have endorsed the proposal.

In the fifth embodiment, once the proposal is accepted by a sufficient number of users, transitioning the blockchain from the private state to the public state may comprise entities running nodes embodying the blockchain disabling a virtual private network on which the nodes are running, and running the nodes on the Internet or other public network instead.

In the fifth embodiment, a right to publish the proposal or endorsements may be restricted to users with administrator rights.

In other embodiments, a right to publish the proposal or endorsements may be restricted to users submitting an appropriate cryptocurrency transaction with the proposal or endorsements. The appropriate cryptocurrency transaction may comprise one or more of: a cryptocurrency burning, evidence of ownership of a quantity of cryptocurrency, a cryptocurrency locking transaction, and/or a cryptocurrency transfer transaction.

In a sixth embodiment of the present disclosure, a blockchain may be transitioned from a public state to a private state by: a user publishing a proposal on the blockchain to transition the blockchain from the public state to the private state; publishing on the blockchain, by zero or more further users, an endorsement of the proposal; and when a predetermined number of endorsements have been published, transitioning the blockchain from the public state to the private state.

In the sixth embodiment the predetermined number may comprise a fraction of a total number of users on the blockchain. For example, if ten users are participating on the blockchain, the predetermined number may comprise a half, and four more users may be required to publish endorsements of the proposal for the proposal to be acted on, with the proposers automatically counting as a fifth endorser.

In the sixth embodiment the proposal may comprise a proposed block height at which the transition occurs, provided a sufficient number of users have endorsed the proposal.

In the sixth embodiment, once the proposal is accepted by the sufficient number of users, transitioning the blockchain from the public state to the private state may comprise entities running nodes embodying the blockchain enabling a virtual private network on which the nodes are subsequently run.

In the sixth embodiment, a right to publish the proposal or endorsements may be restricted to users with administrator rights.

In other embodiments, a right to publish the proposal or endorsements may be restricted to users submitting an appropriate cryptocurrency transaction with the proposal or endorsements. The appropriate cryptocurrency transaction may comprise one or more of: a cryptocurrency burning, evidence of ownership of a quantity of cryptocurrency, a cryptocurrency locking transaction, and/or a cryptocurrency transfer transaction.

In alternate embodiments the proposer may not automatically count as an endorser of the proposal, and may explicitly be required to endorse the proposal with a separate endorsement message.

Those skilled in the art will further appreciate the advantages and superior features found in this disclosure together with other important aspects thereof on reading the detailed description that follows in conjunction with the drawings.

### BRIEF DESCRIPTION OF THE DRAWINGS

The components in the figures are not necessarily to scale, emphasis instead being placed upon illustrating the principles of the present disclosure. In the figures, like reference numerals designate corresponding parts throughout the different views.

FIG. 1 illustrates an embodiment of a blockchain through a peer-to-peer network, with a plurality of network connected devices connected to the peer-to-peer network, in accordance with an embodiment of the present disclosure.

FIG. 2 is a block diagram illustrating a possible structure of a proposal message for transitioning a blockchain from a permissioned state to an open state, in accordance with an embodiment of the present disclosure.

FIG. 3 is a block diagram illustrating a possible structure of a proposal message for transitioning a blockchain from an open state to a permissioned state, in accordance with an embodiment of the present disclosure.

FIG. 4 is a block diagram illustrating a possible structure of a proposal message for transitioning a blockchain from a private state to a public state, in accordance with an embodiment of the present disclosure.

FIG. 5 is a block diagram illustrating a possible structure of a proposal message for transitioning a blockchain from a public state to a private state, in accordance with an embodiment of the present disclosure.

FIG. 6 is a block diagram illustrating a possible structure of a transaction for a cryptocurrency burning, in accordance with an embodiment of the present disclosure.

FIG. 7 is a block diagram illustrating a possible structure of a transaction for a cryptocurrency locking, in accordance with an embodiment of the present disclosure.

FIG. 8 is a block diagram illustrating a possible structure of a transaction for a cryptocurrency transfer, in accordance with an embodiment of the present disclosure.

FIG. 9 is a flow chart illustrating a possible method for transitioning a blockchain from a permissioned state to an open state, in accordance with an embodiment of the present disclosure.

FIG. 10 is a flow chart illustrating a possible method for transitioning a blockchain from an open state to a permissioned state, in accordance with an embodiment of the present disclosure.

FIG. 11 is a flow chart illustrating a possible method for transitioning a blockchain from a public state to a private state, in accordance with an embodiment of the present disclosure.

FIG. 12 is a flow chart illustrating a possible method for transitioning a blockchain from a private state to a public state, in accordance with an embodiment of the present disclosure.

FIG. 13 is a block diagram illustrating a possible structure of an endorsement for a proposal, in accordance with an embodiment of the present disclosure.

FIG. 14 is a block diagram illustrating a possible section of a proposal or an endorsement, in which a blockchain participant may purchase selected administrator rights on a blockchain transitioning from an open state to a permissioned state, in accordance with an embodiment of the present disclosure.

FIG. 15 is a flow chart illustrating a possible method for requesting and receiving VPN access rights through a blockchain, in accordance with an embodiment of the present disclosure.

### DETAILED DESCRIPTION

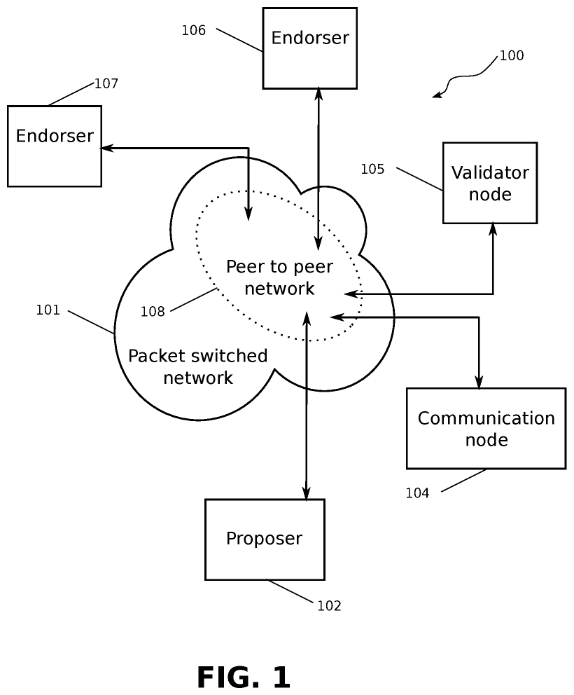

Aspects of this disclosure will be described in the context of an exemplary system of a plurality of network connected devices communicating through the medium of a peer-to-peer network system 100, thereby implementing a blockchain, as shown schematically in FIG. 1.

As depicted, a peer-to-peer network 108 is embodied within a packet switched network 101, through the interconnection of the plurality of network connected devices on the peer-to-peer network 108.

In some embodiments, the peer-to-peer network may comprise a VPN. In other embodiments the peer-to-peer network may be instantiated on the Internet or other public network.

Devices connected to the peer-to-peer network 108 may include a participant on the blockchain known as a proposer 102. In some embodiments the proposer 102 may submit a proposal for transitioning the blockchain from one state to another state, for publication on the blockchain.

Other devices connected to the peer-to-peer network 108 may include network connected devices acting as communication nodes, for example communication node 104 whose role is to maintain a list of other devices connected through the peer-to-peer network, and to forward on received network messages to those devices on the list, possibly independently, or possibly as a response to a request from another network connected device. As one skilled in the art will be aware, no individual communication node is required to have a complete list of all devices, as the process of peer-to-peer networking only requires that a union of a set of all communication nodes contains a complete list of all devices on the peer-to-peer network, and for every pair of network connected devices there is a network route from one device to the other, possibly via a set of one or more nodes. Therefore, the only requirement to be a participant on the peer-to-peer network is to establish a connection to one or more of the communication nodes on said network.

Further devices connected via the peer-to-peer network 108 may include validator nodes, for example validator node 105. Validator nodes are known to those skilled in the art as “miners”, whose role may be to act as a communication node, and may also be to receive messages, records and other transaction or data messages from the peer-to-peer network 108, process them, and transmit the results of said processing back to the peer-to-peer network 108 for potential inclusion in the blockchain.

Further devices connected via the peer-to-peer network may include endorser nodes, for example endorser 106, and endorser 107, that may submit endorsements for proposals to the peer-to-peer network for inclusion on the blockchain.

Each of the devices described above may be implemented through a system comprising a one or a plurality of: a general purpose microprocessor, a digital signal processor (DSP), an application specific instruction set processor (ASIP), a field programmable gate array (FPGA), a dedicated application specific integrated chip (ASIC), or other equivalent integrated or discrete logic circuitry and peripheral circuitry, connected to a tangible storage medium containing instructions which when executed effect methods and techniques described below. The techniques additionally, or alternatively, may be realized at least in part by a computer-readable communication medium or record carrier, that carries or communicates code in the form of instructions or data structures and that can be accessed, read, and/or executed by a computer.

The devices described above may connect to the peer-to-peer network 108 through a direct connection to the packet switched network 101 with a wired connection, or through a wireless connection by association with a wireless access point, a cellular base station, a Bluetooth connection, or other means of connection.

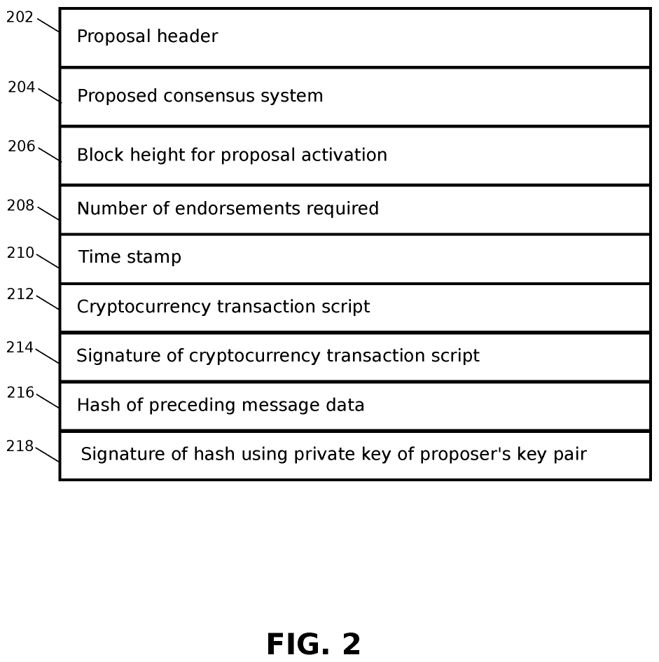

In FIG. 2 a block diagram illustrating a possible structure of a proposal message for transitioning a blockchain from a permissioned state to an open state, in accordance with an embodiment of the present disclosure, is presented.

In an embodiment the proposal message may comprise a proposal header 202, which in some embodiments may comprise: an identifier indicating that the message comprises a proposal message, a size of the message, a protocol for the message, and/or a structure of data included in the message.

In an embodiment the proposal message may comprise a proposed consensus system 204. The proposed consensus system may comprise one or more of: a proof of work, a delayed proof of work, a proof of stake, a delegated proof of stake, a proof of stake velocity, a proof of authority, a proof of weight, a proof of reputation, a proof of elapsed time, a proof of space, a proof of history, a proof of importance, a proof of burn, a proof of identity, a proof of activity, practical or federated or delegated Byzantine fault tolerance, Raft consensus, directed acyclic graph consensus, or a hybrid of two or more of the aforementioned consensus systems.

In an embodiment the proposal message may comprise a block height for proposal activation 206. In some embodiments the block height for proposal activation 206 may comprise a future block height at which the proposal message may be acted on. In other embodiments the block height for proposal activation 206 may comprise a future time at which the proposal message may be acted on by blockchain participants.

In an embodiment the proposal message may comprise a number of endorsements required 208. The number of endorsements required may comprise a predetermined number set during an initial launch of the blockchain. In other embodiments the number of endorsements required may dynamically change as more participants join the blockchain. In some embodiments the number of endorsements required 208 may comprise a percentage of known administrators of the blockchain. In yet other embodiments the number of endorsements required may be set by a prior vote on the blockchain.

The proposal message may comprise a time stamp 210. In an embodiment the time stamp may comprise a time at which the proposal message was constructed. The proposal message may also comprise a plurality of time stamps.

The proposal message may comprise a cryptocurrency transaction script 212. In some embodiments the proposal message may only be considered valid if it comprises the cryptocurrency transaction script 212, said transaction script satisfying one or more conditions. The one or more conditions may comprise: burning a predetermined quantity of cryptocurrency, locking a predetermined quantity of cryptocurrency for a period of time making the predetermined quantity of cryptocurrency unusable, and creating a pool of a predetermined cryptocurrency that may at a future point be distributed among endorsers of the proposal message.

The proposal message may comprise a signature 214 of the cryptocurrency transaction script, whereby the cryptocurrency transaction is validated.

The proposal message may comprise a message hash 216 of all or part of proceeding contents of the proposal message. The message hash 216 may be calculated using a cryptographic hash algorithm, for example: Secure Hash Algorithm (SHA), RACE Integrity Primitives Evaluation Message Digest (RIPEMD), Whirlpool, Scrypt, HAS-160, BLAKE, or other cryptographic hash function applied to all or part of the preceding content of the preceding certificate validation message contents, where a hash output cannot be determined from a hash input other than by an application of the cryptographic hash function to the hash input.

The proposal message may comprise a signature 218 of the message hash 216. The signature 218 may be generated with a digital signature algorithm using a private key associated with a generator or publisher of the proposal message, in order to provide for the veracity of the proposal message. The digital signature algorithm used may be one of an elliptic curve digital signature algorithm (ECDSA), a digital signature algorithm (DSA), a Rivest-Shamir-Adleman (RSA), or some other secure asymmetric key digital signing algorithm.

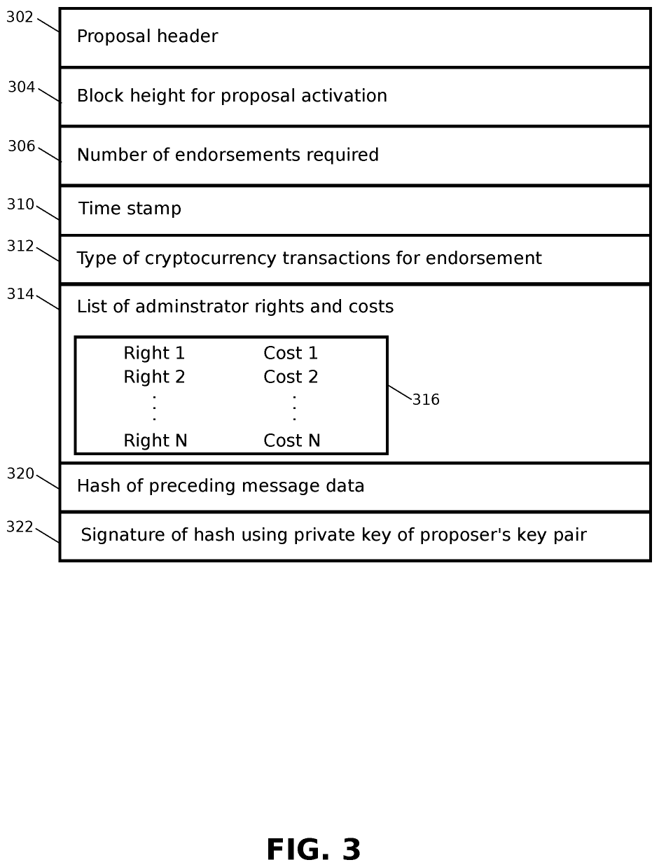

In FIG. 3 a block diagram illustrating a possible structure of a proposal message for transitioning a blockchain from an open state to a permissioned state, in accordance with an embodiment of the present disclosure, is presented.

In an embodiment the proposal message may comprise a proposal header 302, which in some embodiments may comprise: an identifier indicating that the message comprises a proposal message, a size of the message, a protocol for the message, and/or a structure of data included in the message.

In an embodiment the proposal message may comprise a block height for proposal activation 304. In some embodiments the block height for proposal activation 304 may comprise a future block height at which the proposal message may be acted on. In other embodiments the block height for proposal activation 304 may comprise a future time at which the proposal message may be acted on by blockchain participants.

In an embodiment the proposal message may comprise a number of endorsements required 306. The number of endorsements required may comprise a predetermined number set during an initial launch of the blockchain. In other embodiments the number of endorsements required may dynamically change as more participants join the blockchain. In some embodiments the number of endorsements required 306 may be set by a prior vote on the blockchain.

The proposal message may comprise a time stamp 310. In an embodiment the time stamp may comprise a time at which the proposal message was constructed. The proposal message may also comprise a plurality of time stamps.

The proposal message may comprise a cryptocurrency transaction type 312. In an embodiment the cryptocurrency transaction type may stipulate an address to transfer a predetermined number of cryptocurrency units to an address. In some embodiments the address may comprise a “burn” address, that is, cryptocurrency transferred to the address may not subsequently be redeemable. In other embodiments the cryptocurrency transaction type may comprise a cryptocurrency locking transaction, that is, a predetermined number of cryptocurrency units may not be spendable for a predetermined period of time. In yet other embodiments the cryptocurrency transaction type may comprise a transfer of cryptocurrency units to an address associated with an author of the proposal message.

The proposal message may comprise a list 314 of administrator rights and associated costs. In an embodiment the list 314 may comprise a table 316 listing a plurality of administrator rights and costs. For example, administrator rights may include: a right to mine blocks, a right to read data, a right to write data, a right to create new cryptocurrency assets, a right to send cryptocurrency assets, a right to receive cryptocurrency assets, a right to assign administrator rights to other participants, a right to revoke administrator rights from other participants, and a right to access the blockchain. Each right may have an associated cost, which in some embodiments may be listed in the table 316, and which may be purchased by participants submitting a transaction in compliance with the cryptocurrency transaction type 312, specifying the right purchased, and transferring a cryptocurrency amount corresponding to a cost listed in the table 316.

The proposal message may comprise a message hash 320 of all or part of proceeding contents of the proposal message. The message hash 320 may be calculated using a cryptographic hash algorithm, for example: SHA, RIPEMD, Whirlpool, Scrypt, HAS-160, BLAKE, or other cryptographic hash function applied to all or part of the preceding content of the preceding certificate validation message contents, where a hash output cannot be determined from a hash input other than by an application of the cryptographic hash function to the hash input.

The proposal message may comprise a signature 322 of the message hash 320. The signature 322 may be generated with a digital signature algorithm using a private key associated with a generator or publisher of the proposal message, in order to provide for the veracity of the proposal message. The digital signature algorithm used may be one of ECDSA, DSA, an RSA, or some other secure asymmetric key digital signing algorithm.

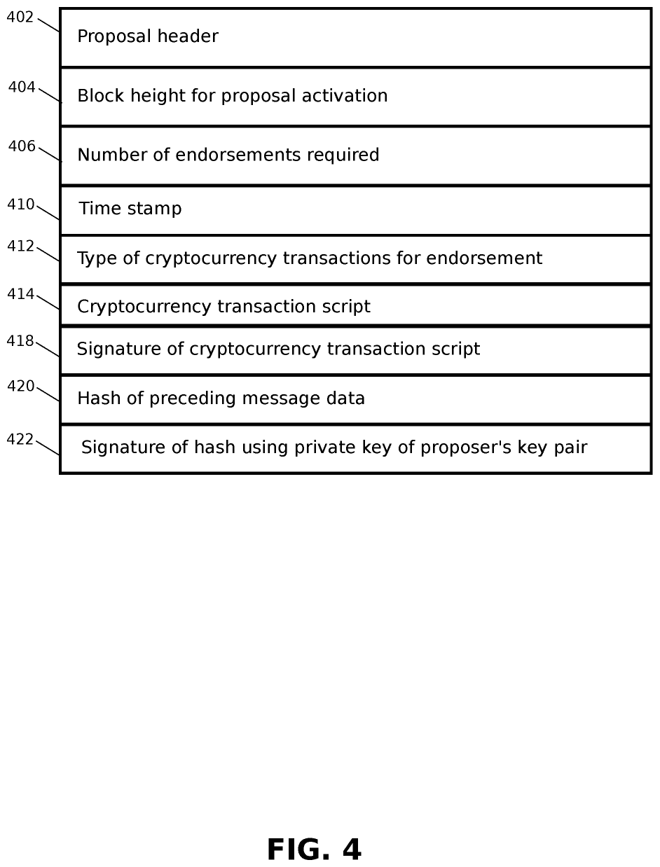

In FIG. 4 a block diagram illustrating a possible structure of a proposal message for transitioning a blockchain from a private state to a public state, in accordance with an embodiment of the present disclosure, is presented.

In an embodiment the proposal message may comprise a proposal header 402, which in some embodiments may comprise: an identifier indicating that the message comprises a proposal message, a size of the message, a protocol for the message, and/or a structure of data included in the message.

In an embodiment the proposal message may comprise a block height for proposal activation 404. In some embodiments the block height for proposal activation 404 may comprise a future block height at which the proposal message may be acted on. In other embodiment the block height for proposal activation 404 may comprise a future time at which the proposal message may be acted on by blockchain participants.

In an embodiment the proposal message may comprise a number of endorsements required 406. The number of endorsements required may comprise a predetermined number set during an initial launch of the blockchain. In other embodiments the number of endorsements required may dynamically change as more participants join the blockchain. In some embodiments the number of endorsements required 406 may be set by a prior vote on the blockchain.

The proposal message may comprise a time stamp 410. In an embodiment the time stamp may comprise a time at which the proposal message was constructed. The proposal message may also comprise a plurality of time stamps.

In some embodiments the blockchain may comprise an open blockchain with an associated cryptocurrency. The proposal message may then comprise a cryptocurrency transaction type 412. In an embodiment the cryptocurrency transaction type 412 may stipulate an address to transfer a predetermined number of cryptocurrency units to. In some embodiments the address may comprise a “burn” address, that is, cryptocurrency transferred to the address may not subsequently be redeemable. In other embodiments the cryptocurrency transaction type may comprise a cryptocurrency locking transaction, that is, a predetermined number of cryptocurrency units may not be spendable for a predetermined period of time. In yet other embodiments the cryptocurrency transaction type may comprise a transfer of cryptocurrency units to an address associated with an author of the proposal message.

In some embodiments the proposal message may comprise a cryptocurrency transaction script 414. The cryptocurrency transaction script may embody a cryptocurrency transaction required under the blockchain consensus system for proposing a blockchain transition. In some embodiments the cryptocurrency transaction may “burn” a predetermined quantity of cryptocurrency in order to validate the proposal message. In further embodiments, the cryptocurrency transaction may be invalidated if the proposal message is not generally accepted by a majority of blockchain participants.

In some embodiments the proposal message may comprise a signature 418 of the cryptocurrency transaction script 414, which may validate the cryptocurrency transaction.

In some embodiments, the proposal message may comprise a message hash 420 of all or part of proceeding contents of the proposal message. The message hash 420 may be calculated using a cryptographic hash algorithm, for example: SHA, RIPEMD, Whirlpool, Scrypt, HAS-160, BLAKE, or other cryptographic hash function applied to all or part of the preceding content of the preceding certificate validation message contents, where a hash output cannot be determined from a hash input other than by an application of the cryptographic hash function to the hash input.

The proposal message may comprise a signature 422 of the message hash 420. The signature 422 may be generated with a digital signature algorithm using a private key associated with a generator or publisher of the proposal message, in order to provide for the veracity of the proposal message. The digital signature algorithm used may be one of ECDSA, DSA, an RSA, or some other secure asymmetric key digital signing algorithm.

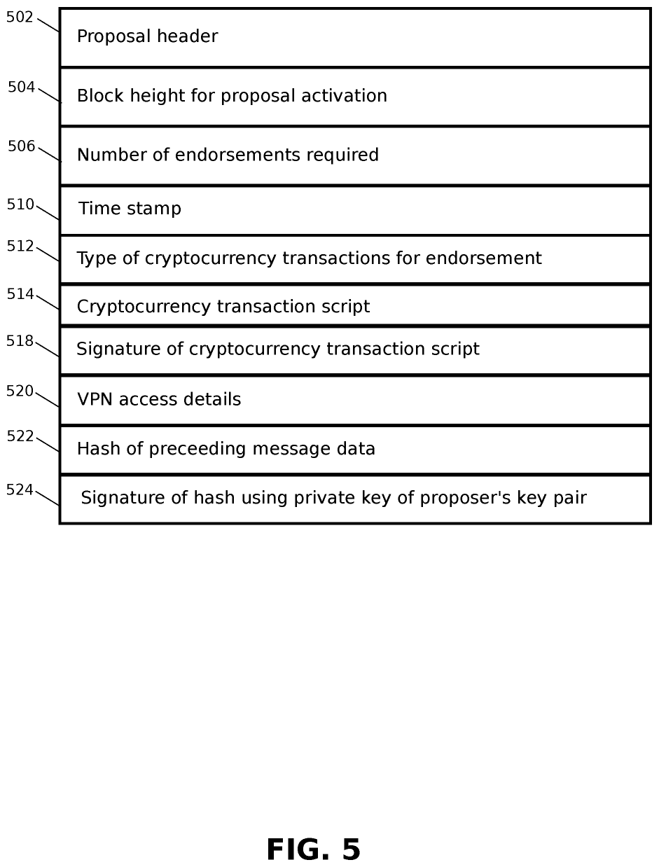

In FIG. 5 a block diagram illustrating a possible structure of a proposal message for transitioning a blockchain from a public state to a private state, in accordance with an embodiment of the present disclosure, is presented.

In an embodiment the proposal message may comprise a proposal header 502, which in some embodiments may comprise: an identifier indicating that the message comprises a proposal message, a size of the message, a protocol for the message, and/or a structure of data included in the message.

In an embodiment the proposal message may comprise a block height for proposal activation 504. In some embodiments the block height for proposal activation 504 may comprise a future block height at which the proposal message may be acted on. In other embodiment the block height for proposal activation 504 may comprise a future time at which the proposal message may be acted on by blockchain participants.

In an embodiment the proposal message may comprise a number of endorsements required 506. The number of endorsements required may comprise a predetermined number set during an initial launch of the blockchain. In other embodiments the number of endorsements required may dynamically change as more participants join the blockchain. In some embodiments the number of endorsements required 506 may be set by a prior vote on the blockchain.

The proposal message may comprise a time stamp 510. In an embodiment the time stamp may comprise a time at which the proposal message was constructed. The proposal message may also comprise a plurality of time stamps.

In some embodiments the blockchain may comprise an open blockchain with an associated cryptocurrency. The proposal message may then comprise a cryptocurrency transaction type 512. In an embodiment the cryptocurrency transaction type 512 may stipulate an address to transfer a predetermined number of cryptocurrency units to. In some embodiments the address may comprise a “burn” address, that is, cryptocurrency transferred to the address may not subsequently be redeemable. In other embodiments the cryptocurrency transaction type may comprise a cryptocurrency locking transaction, that is, a predetermined number of cryptocurrency units may not be spendable for a predetermined period of time. In yet other embodiments the cryptocurrency transaction type may comprise a transfer of cryptocurrency units to an address associated with an author of the proposal message.

In some embodiments the proposal message may comprise a cryptocurrency transaction script 514. The cryptocurrency transaction script may embody a cryptocurrency transaction required under the blockchain consensus system for proposing a blockchain transition. In some embodiments the cryptocurrency transaction may “burn” a predetermined quantity of cryptocurrency in order to validate the proposal message. In further embodiments, the cryptocurrency transaction may be invalidated if the proposal message is not generally accepted by a majority of blockchain participants.

In some embodiments the proposal message may comprise a signature 518 of the cryptocurrency transaction script 514, which may validate the cryptocurrency transaction.

In some embodiments the proposal message may comprise VPN access details 520. The VPN access details 520 may be encrypted to ensure that they are not public information. In further embodiments, participants may receive a decryption key by endorsing the proposal message.

In some embodiments, the proposal message may comprise a message hash 522 of all or part of proceeding contents of the proposal message. The message hash 522 may be calculated using a cryptographic hash algorithm, for example: SHA, RIPEMD, Whirlpool, Scrypt, HAS-160, BLAKE, or other cryptographic hash function applied to all or part of the preceding content of the preceding certificate validation message contents, where a hash output cannot be determined from a hash input other than by an application of the cryptographic hash function to the hash input.

The proposal message may comprise a signature 524 of the message hash 522. The signature 524 may be generated with a digital signature algorithm using a private key associated with a generator or publisher of the proposal message, in order to provide for the veracity of the proposal message. The digital signature algorithm used may be one of ECDSA, DSA, an RSA, or some other secure asymmetric key digital signing algorithm.

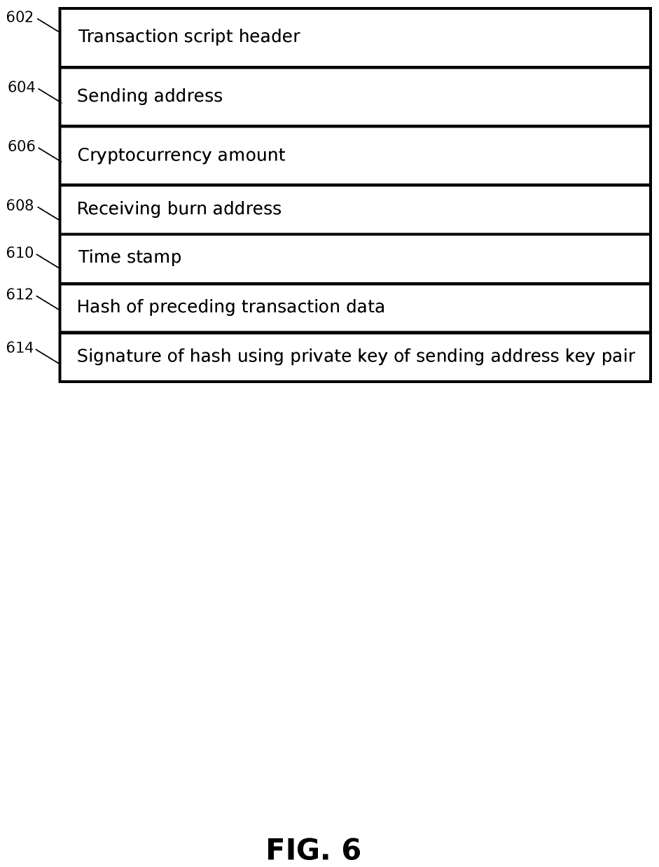

In FIG. 6 a block diagram illustrating a possible structure of a transaction for a cryptocurrency burning, in accordance with an embodiment of the present disclosure, is presented.

In an embodiment the transaction may comprise a transaction script header 602, which in some embodiments may comprise: an identifier indicating that the transaction comprises a cryptocurrency transaction, a size of the transaction, a protocol for the transaction, a script language for the transaction, and/or a structure of data included in the transaction.

In an embodiment the transaction may comprise a sending address 604. In some embodiments the sending address 604 may comprise a public cryptographic key. In other embodiments the sending address may comprise a transformation of a public cryptographic key through an application of hash functions, check-sums, and character set encoding schemes.

In an embodiment the transaction may comprise a cryptocurrency amount 606 specifying a quantity of cryptocurrency to transfer.

In some embodiments the transaction may comprise a receiving burn address 608, which may be selected such that cryptocurrency transferred to the receiving burn address 608 may not subsequently be redeemable. For example the receiving burn address 608 may comprise an address for which there is no private key.

The transaction may comprise a time stamp 610. In an embodiment the time stamp may comprise a time at which the transaction was constructed. The transaction may also comprise a plurality of time stamps.

In some embodiments, the transaction may comprise a message hash 612 of all or part of proceeding contents of the transaction. The message hash 612 may be calculated using a cryptographic hash algorithm, for example: SHA, RIPEMD, Whirlpool, Scrypt, HAS-160, BLAKE, or other cryptographic hash function applied to all or part of the preceding content of the preceding certificate validation message contents, where a hash output cannot be determined from a hash input other than by an application of the cryptographic hash function to the hash input.

The transaction may comprise a signature 614 of the message hash 612. The signature 614 may be generated with a digital signature algorithm using a private key associated with a generator or publisher of the transaction, in order to provide for the veracity of the transaction. The digital signature algorithm used may be one of ECDSA, DSA, an RSA, or some other secure asymmetric key digital signing algorithm.

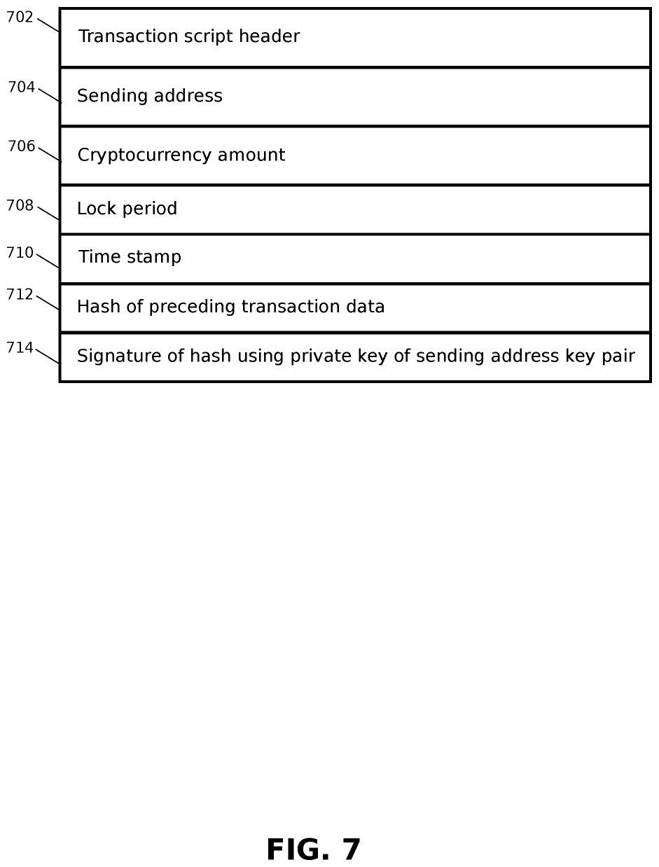

In FIG. 7 a block diagram illustrating a possible structure of a transaction for a cryptocurrency locking, in accordance with an embodiment of the present disclosure, is presented.

In an embodiment the transaction may comprise a transaction script header 702, which in some embodiments may comprise: an identifier indicating that the transaction comprises a cryptocurrency transaction, a size of the transaction, a protocol for the transaction, a script language for the transaction, and/or a structure of data included in the transaction.

In an embodiment the transaction may comprise a sending address 704. In some embodiments the sending address 704 may comprise a public cryptographic key. In other embodiments the sending address may comprise a transformation of a public cryptographic key through an application of hash functions, check-sums, and character set encoding schemes.

In an embodiment the transaction may comprise a cryptocurrency amount 706 specifying a quantity of cryptocurrency to lock.

In some embodiments the transaction may comprise a cryptocurrency locking period 708. The cryptocurrency locking period 708 may specify that the cryptocurrency amount 706 may not be spendable for a period of time corresponding to the cryptocurrency locking period 708. In other embodiments the cryptocurrency locking period 708 may specify a number of blocks that must be added to the blockchain before the cryptocurrency amount 706 may be spent.

The transaction may comprise a time stamp 710. In an embodiment the time stamp may comprise a time at which the transaction was constructed. The transaction may also comprise a plurality of time stamps.

In some embodiments, the transaction may comprise a message hash 712 of all or part of proceeding contents of the transaction. The message hash 712 may be calculated using a cryptographic hash algorithm, for example: SHA, RIPEMD, Whirlpool, Scrypt, HAS-160, BLAKE, or other cryptographic hash function applied to all or part of the preceding content of the preceding certificate validation message contents, where a hash output cannot be determined from a hash input other than by an application of the cryptographic hash function to the hash input.

The transaction may comprise a signature 714 of the message hash 712. The signature 714 may be generated with a digital signature algorithm using a private key associated with a generator or publisher of the transaction, in order to provide for the veracity of the transaction. The digital signature algorithm used may be one of ECDSA, DSA, an RSA, or some other secure asymmetric key digital signing algorithm.

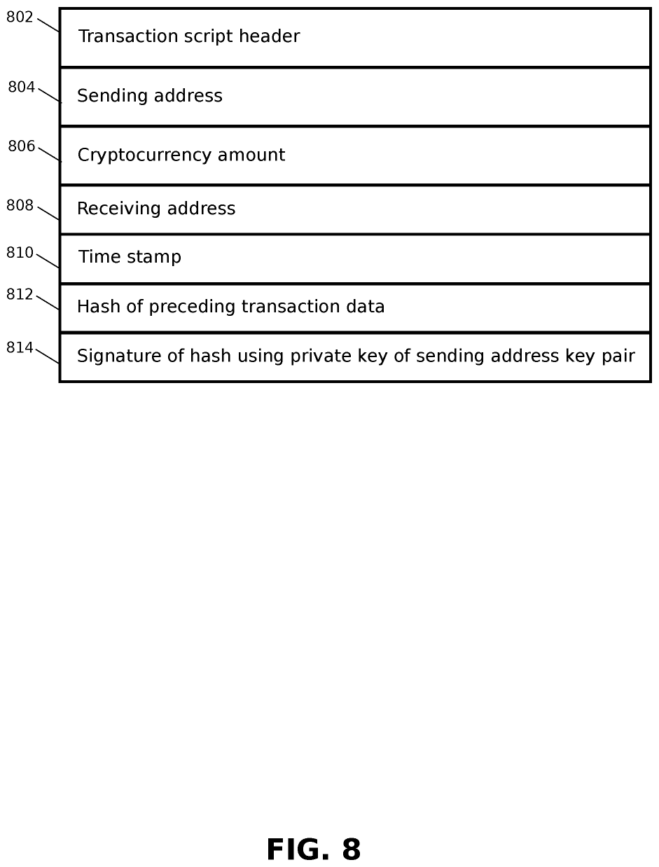

In FIG. 8 a block diagram illustrating a possible structure of a transaction for a cryptocurrency transfer, in accordance with an embodiment of the present disclosure, is presented.

In an embodiment the transaction may comprise a transaction script header 802, which in some embodiments may comprise: an identifier indicating that the transaction comprises a cryptocurrency transaction, a size of the transaction, a protocol for the transaction, a script language for the transaction, and/or a structure of data included in the transaction.

In an embodiment the transaction may comprise a sending address 804. In some embodiments the sending address 804 may comprise a public cryptographic key. In other embodiments the sending address may comprise a transformation of a public cryptographic key through an application of hash functions, check-sums, and character set encoding schemes.

In an embodiment the transaction may comprise a cryptocurrency amount 806 specifying a quantity of cryptocurrency to transfer.

In some embodiments the transaction may comprise a receiving address 808. In some embodiments the receiving address 808 may comprise a public cryptographic key. In other embodiments the sending address may comprise a transformation of a public cryptographic key through an application of hash functions, check-sums, and character set encoding schemes. The receiving address 808 may comprise a plurality of receiving addresses.

The transaction may comprise a time stamp 810. In an embodiment the time stamp may comprise a time at which the transaction was constructed. The transaction may also comprise a plurality of time stamps.

In some embodiments, the transaction may comprise a message hash 812 of all or part of proceeding contents of the transaction. The message hash 812 may be calculated using a cryptographic hash algorithm, for example: SHA, RIPEMD, Whirlpool, Scrypt, HAS-160, BLAKE, or other cryptographic hash function applied to all or part of the preceding content of the preceding certificate validation message contents, where a hash output cannot be determined from a hash input other than by an application of the cryptographic hash function to the hash input.

The transaction may comprise a signature 814 of the message hash 812. The signature 814 may be generated with a digital signature algorithm using a private key associated with a generator or publisher of the transaction, in order to provide for the veracity of the transaction. The digital signature algorithm used may be one of ECDSA, DSA, an RSA, or some other secure asymmetric key digital signing algorithm.

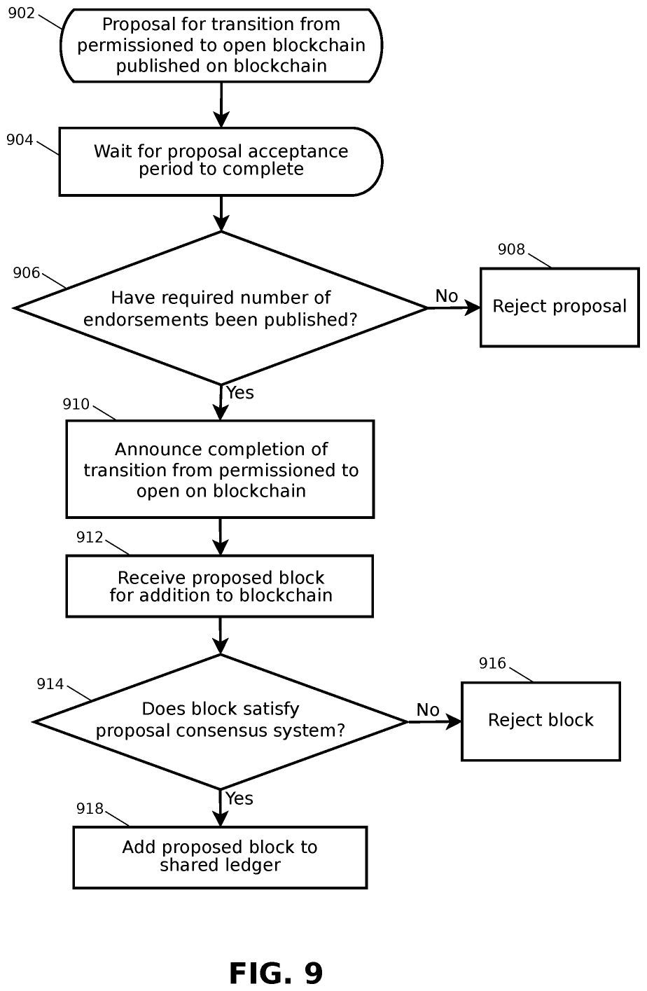

In FIG. 9 a flow chart illustrating a possible method for transitioning a blockchain from a permissioned state to an open state, in accordance with an embodiment of the present disclosure, is presented.

In the embodiment, operations may commence with publishing, on a blockchain, a proposal for a transition of the blockchain from a permissioned state to an open state, as shown in step 902.

In the embodiment, a waiting period for acceptance of the proposal may complete, as shown in step 904. During the waiting period, participants on the blockchain may submit endorsements of the proposal to the blockchain.

In the embodiment, operations may proceed with a tally of the endorsements, in order to determine if a required number of endorsements were published on the blockchain during the waiting period, as shown in step 906.

If the tally shows that the required number of endorsements was not reached, operations may proceed to step 908, and the proposal may be rejected by the participants on the blockchain.

If the tally shows that the required number of endorsements was reached, operations may proceed to step 910.

In some embodiments, in step 910 an announcement of completion of the transition from the permissioned state to the open state may be made on the blockchain.

Operations may then proceed to step 912, in which a proposed block for addition to the blockchain may be received by participants on the network.

Under a consensus protocol stipulated in the proposal for transition and transitioned to under step 910, participants may examine the proposed block to verify that the proposed block satisfies conditions of the consensus protocol, as shown in step 914.

If the new block does not satisfy the consensus system, the new block may be rejected, as shown in step 916.

If the new block does satisfy the consensus system, the new block may be accepted and added to the blockchain, as shown in step 918. In some embodiments a component of the blockchain to which blocks are added may be referred to as a shared ledger.

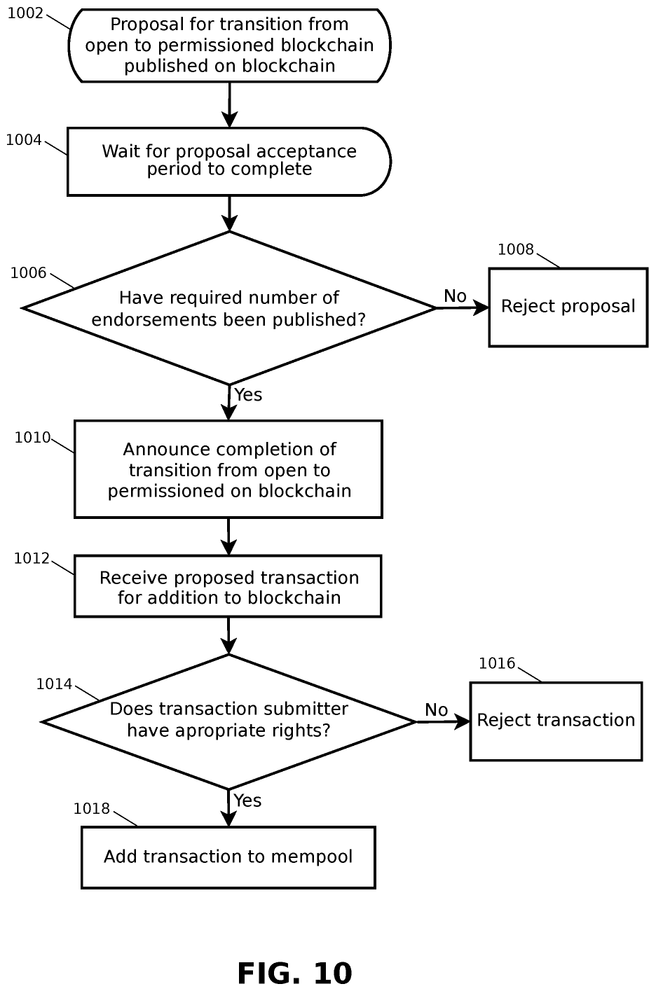

In FIG. 10 a flow chart illustrating a possible method for transitioning a blockchain from an open state to a permissioned state, in accordance with an embodiment of the present disclosure, is presented.

In an embodiment, operations may commence with publishing, on a blockchain, a proposal for a transition of the blockchain from the open state to the permissioned state, as shown in step 1002.

In the embodiment, a waiting period for acceptance of the proposal may complete, as shown in step 1004. During the waiting period, participants on the blockchain may submit endorsements of the proposal to the blockchain.

In the embodiment, operations may proceed with a tally of the endorsements, in order to determine if a required number of endorsements were published on the blockchain during the waiting period, as shown in step 1006.

If the tally shows that the required number of endorsements was not reached, operations may proceed to step 1008, and the proposal may be rejected by the participants on the blockchain.

If the tally shows that the required number of endorsements was reached, operations may proceed to step 1010.

In some embodiments, in step 1010 an announcement of completion of the transition from the permissioned state to the open state may be made on the blockchain.

Operations may then proceed to step 1012, in which a proposed transaction for addition to the blockchain may be received by participants on the network.

In some embodiments, under permissions stipulated in the proposal for transition and transitioned to under step 1010, participants may examine the proposed transaction and credentials of a submitter of the proposed transaction to verify that the submitter possesses appropriate rights to submit the proposed transaction, as shown in step 1014.

If the submitter does not posses appropriate rights, the proposed transaction may be rejected, as shown in step 1016.

If the submitter does posses appropriate rights, the proposed transaction may be accepted and added to a memory pool for future inclusion in a new block, as shown in step 1018. In some embodiments the memory pool, or “mempool” is a term referring to a list of unprocessed transactions awaiting inclusion in the new block.

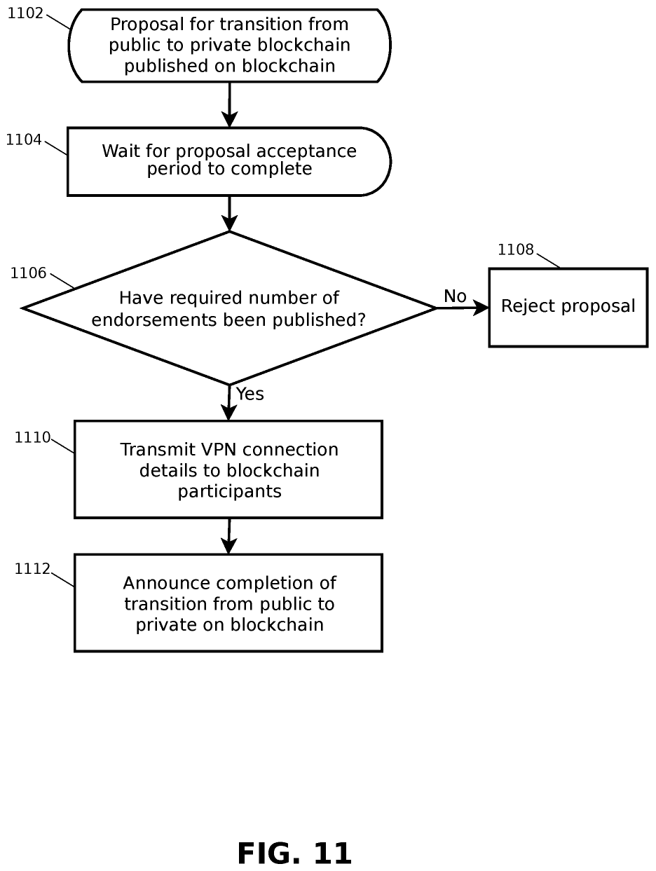

In FIG. 11 a flow chart illustrating a possible method for transitioning a blockchain from a public state to a private state, in accordance with an embodiment of the present disclosure, is presented.

In the embodiment, operations may commence with publishing, on a blockchain, a proposal for a transition of the blockchain from the public state to the private state, as shown in step 1102.

In the embodiment, a waiting period for acceptance of the proposal may complete, as shown in step 1104. During the waiting period, participants on the blockchain may submit endorsements of the proposal to the blockchain.

In the embodiment, operations may proceed with a tally of the endorsements, in order to determine if a required number of endorsements were published on the blockchain during the waiting period, as shown in step 1106.

If the tally shows that the required number of endorsements was not reached, operations may proceed to step 1108, and the proposal may be rejected by the participants on the blockchain.

If the tally shows that the required number of endorsements was reached, operations may proceed to step 1110.

In step 1110 connection details and credentials for a VPN may be transmitted to participants on the blockchain. In some embodiments the connection details and credentials may be transmitted out of band, for example through email. In other embodiments the connection details and credentials may be published on the blockchain in encrypted form, for example by encrypting the connection details and credentials with public encryption keys supplied in endorsement messages by blockchain participants.

Operations may then proceed to step 1112, in which an announcement of completion of the transition may be made on the blockchain.

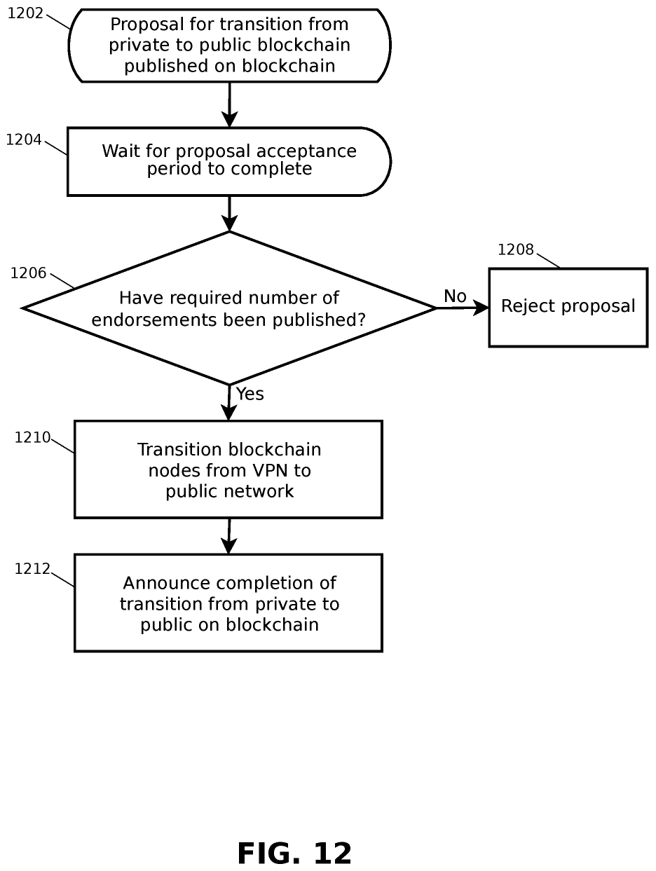

In FIG. 12 a flow chart illustrating a possible method for transitioning a blockchain from a private state to a public state, in accordance with an embodiment of the present disclosure, is presented.

In an embodiment, operations may commence with publishing, on a blockchain, a proposal for a transition of the blockchain from a private state to a public state, as shown in step 1202.

In the embodiment, a waiting period for acceptance of the proposal may complete, as shown in step 1204. During the waiting period, participants on the blockchain may submit endorsements of the proposal to the blockchain.

In the embodiment, operations may proceed with a tally of the endorsements, in order to determine if a required number of endorsements were published on the blockchain during the waiting period, as shown in step 1206.

If the tally shows that the required number of endorsements was not reached, operations may proceed to step 1208, and the proposal may be rejected by the participants on the blockchain.

If the tally shows that the required number of endorsements was reached, operations may proceed to step 1210.

In step 1210 the blockchain may be transitioned from a private VPN to a public network by all nodes maintaining the blockchain.

Operations may then proceed to step 1212, in which an announcement of completion of the transition from the private state to the public state may be made on the blockchain.

In other embodiments, an order of steps may be reversed, and in particular step 1210 may occur after step 1212.

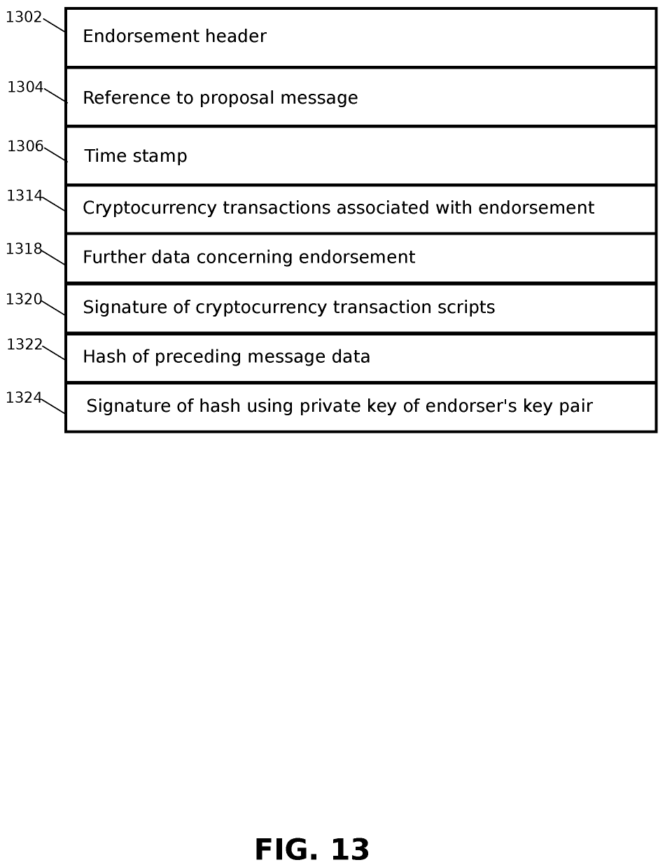

In FIG. 13 a block diagram illustrating a possible structure of an endorsement for a proposal, in accordance with an embodiment of the present disclosure, is presented.

In an embodiment the endorsement may comprise an endorsement header 1302, which in some embodiments may comprise: an identifier indicating that the endorsement comprises an endorsement message, a size of the endorsement, a protocol version for the endorsement, and/or a structure of data included in the transaction.

In an embodiment the endorsement may comprise a reference to a proposal message 1304. In some embodiments the reference may comprise one or more of: a hash of the proposal message, a location on the blockchain of the proposal message specified either as a block height or a time of submission or both, an author of the proposal message, and a summary of the proposal message.

In some embodiments the endorsement may comprise a time stamp 1306. In an embodiment the time stamp may comprise a time at which the endorsement was constructed. The endorsement may also comprise a plurality of time stamps.

In some embodiments the endorsement may comprise one or more cryptocurrency transactions 1314 associated with the endorsement. As has previously been disclosed, various proposals for blockchain status transitions may comprise a requirement for cryptocurrency transactions to purchase additional rights on the blockchain after the transition. The cryptocurrency transactions 1314 may comprise such transactions.

In some enhancements to some embodiments an endorsement may require a payment, either to the proposer of the proposal, or to a burn address, of a quantity of cryptocurrency in order to validate the endorsement. The cryptocurrency transactions 1314 may comprise such transactions.

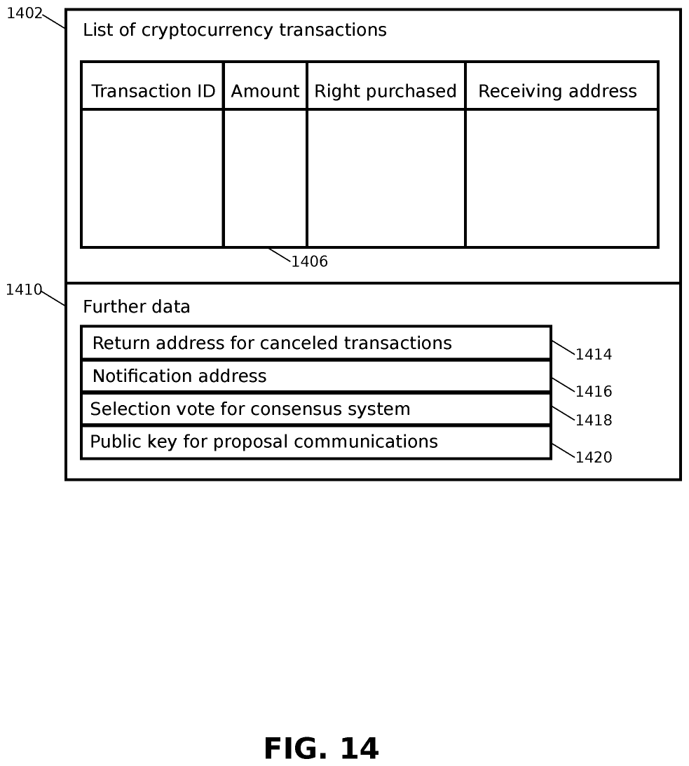

Additional information pertaining to the cryptocurrency transactions that may be present in some embodiments is provided in FIG. 14 below.

In some embodiments, the endorsement may comprise further data concerning the endorsement 1318. For example, further data may comprise text explaining the endorser's rationale for endorsing the proposal. Further data may also comprise additional data concerning the endorser, such as other public addresses controlled by the endorser.

In some embodiments the endorsement may comprise a signature 1320 of cryptocurrency transactions 1314 present in the endorsement. The signature 1320 may be generated with a digital signature algorithm using a private key associated with a generator or publisher of the transaction, in order to provide for the veracity of the transaction. The digital signature algorithm used may be one of ECDSA, DSA, an RSA, or some other secure asymmetric key digital signing algorithm.

In some embodiments, the endorsement may comprise a message hash 1322 of all or part of proceeding contents of the transaction. The message hash 1322 may be calculated using a cryptographic hash algorithm, for example: SHA, RIPEMD, Whirlpool, Scrypt, HAS-160, BLAKE, or other cryptographic hash function applied to all or part of the preceding content of the preceding certificate validation message contents, where a hash output cannot be determined from a hash input other than by an application of the cryptographic hash function to the hash input.

The transaction may comprise a signature 1324 of the message hash 1322. The signature 1324 may be generated with a digital signature algorithm using a private key associated with a generator or publisher of the endorsement, in order to provide for the veracity of the endorsement and to ensure double voting does not occur. The digital signature algorithm used may be one of ECDSA, DSA, an RSA, or some other secure asymmetric key digital signing algorithm.

In FIG. 14 a block diagram illustrating a section of a proposal or an endorsement, in which a blockchain participant may purchase selected administrator rights on a blockchain transitioning from an open state to a permissioned state, in accordance with an embodiment of the present disclosure, is presented.

In some embodiments the section may comprise a list 1402 of cryptocurrency transactions associated with the proposal or the endorsement.

The list may comprise a table of transactions 1406, said table comprising columns representing a transaction identifier, an amount of cryptocurrency, a right purchased and a receiving address for the amount of cryptocurrency. Each row of the table may represent a single transaction. In some embodiments the right purchased may comprise a reference to an offered right within a proposal.

In some embodiments the section may comprise further data 1410 concerning the endorsement or the proposal.

The further data 1410 may, in some embodiments, comprise one or more of the following:

A return address for canceled transactions 1414, to which cryptocurrency amounts may be returned if the proposal does not receive enough endorsements;

A notification address 1416, which may comprise an email address or other messaging address, through which if a blockchain is transitioned to a private state or a closed state, the endorser may be informed of the location of the blockchain after the transition, or whereby credentials for accessing the blockchain after the transition may be delivered;

A selection vote for a consensus system 1418, whereby the proposal may contain a choice of consensus systems, and the endorser may cast a vote for which consensus system to use after transitioning; and

A public key for proposal communications 1420, whereby information concerning the proposal may be delivered in encrypted form through the blockchain to the endorser by encrypting said information using the public key.

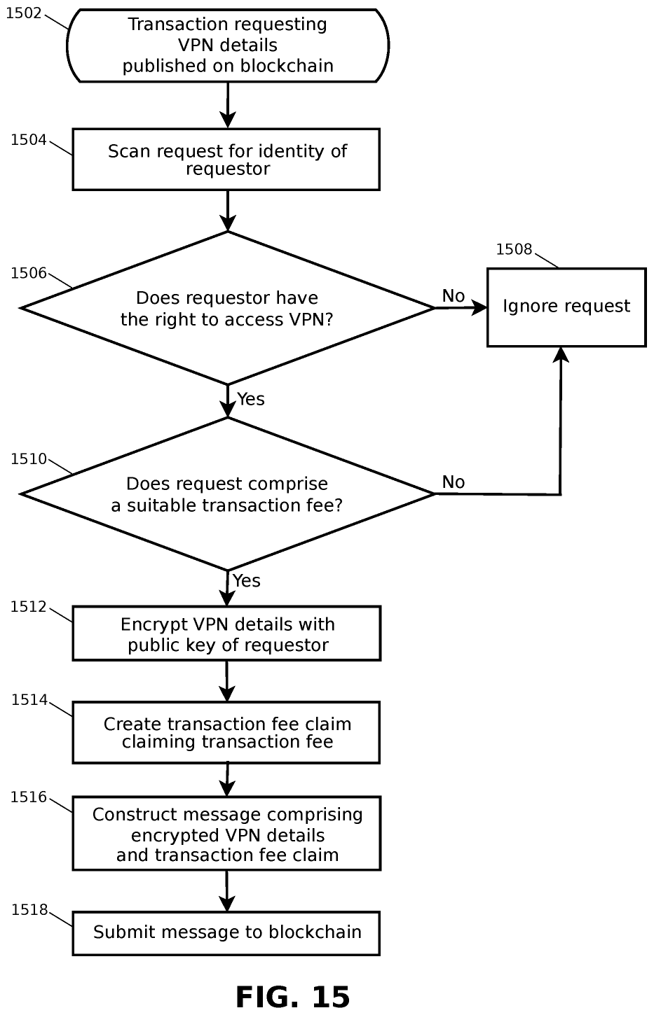

In FIG. 15 a flow chart illustrating a possible method for requesting and receiving VPN access rights through a blockchain, in accordance with an embodiment of the present disclosure, is presented.

In some embodiments of the present disclosure, it may be necessary to transmit details for re-joining the blockchain once the blockchain has transitioned from a public state to a private state. This may be enabled by relevant participants making a request for connection details to a VPN on the blockchain, and for other parties submitting the VPN connection details in encrypted form on the blockchain before transition occurs.

In an embodiment, operations may commence with a requestor publishing a request for VPN connection details on the blockchain, as shown in step 1502.

Operations may proceed by a participant scanning the request for an identity of the requestor, as shown in step 1504.

Operations may then continue to step 1506, in which the participant may determine if the requestor has a right to access the VPN. If the requestor does not have the right, operations may proceed to step 1508, and the participant may ignore the request.

If the participant determines that the requestor does have the right, operations may proceed to step 1510.

In step 1510, in some embodiments, the participant may determine whether the request comprises a suitable transaction fee required in order to obtain VPN access. If the request does not comprise said suitable transaction fee, or an amount of the transaction fee is not sufficiently high, operations may proceed to step 1508, and the participant may ignore the request.

If the request does comprise a suitable transaction fee, operations may proceed to step 1512, and the participant may encrypt VPN access credentials using a public key of the requestor. In some embodiments, the request may comprise the public key, and the public key may therefore be retrieved from the request.

In some embodiments the participant may then proceed to create a transaction fee claim, in order to redeem the suitable transaction fee, as shown in step 1514.

Operations may then proceed to step 1516, in which the participant may construct a message comprising the VPN access credentials encrypted with the public key and the transaction fee claim.

Operations may then proceed to the participant submitting the message for publication on the blockchain, as shown in step 1518.

Those skilled in the art will recognize that components of messages presented in the above disclosure may be organized in different orders while maintaining the meaning and functionality of said messages.

Those skilled in the art will also recognize that steps undertaken in processes described in the above disclosure may be taken in a different order while still maintaining an outcome of the processes.

The technology described herein is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, processor-based systems, programmable consumer electronics, network PCs, minicomputers, mainframe computers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor such as a Pentium® processor, a Pentium® Pro processor, a 8051 processor, a MIPS® processor, a Power PC® processor, or an Alpha® processor. In addition, the processor may be any conventional special purpose processor such as a digital signal processor or a graphics processor. The processor typically has conventional address lines, conventional data lines, and one or more conventional control lines.

The system is comprised of various modules as discussed in detail. As can be appreciated by one of ordinary skill in the art, each of the modules comprises various sub-routines, procedures, definitional statements and macros. Each of the modules are typically separately compiled and linked into a single executable program. Therefore, the description of each of the modules is used for convenience to describe the functionality of the preferred system. Thus, the processes that are undergone by each of the modules may be arbitrarily redistributed to one of the other modules, combined together in a single module, or made available in, for example, a shareable dynamic-link library.

The system may be used in connection with various operating systems such as Linux®, UNIX® or Microsoft Windows®.

The system may be written in any conventional programming language such as C, C++, Pascal, or Java, and ran under a conventional operating system. C, C++, Pascal, Java, and FORTRAN are industry standard programming languages for which many commercial compilers can be used to create executable code. The system may also be written using interpreted languages such as Perl, Python or Ruby, or languages that may either be compiled or interpreted, such as BASIC or Lisp.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a DSP, an ASIC, an FPGA or other programmable logic device, discrete gate or transistor logic, discrete hardware components, or any combination thereof designed to perform the functions described herein. A general purpose processor may be a microprocessor, but in the alternative, the processor may be any conventional processor, controller, micro-controller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more example embodiments, the functions and methods described may be implemented in hardware, software, or firmware executed on a processor, or any combination thereof. If implemented in software, the functions may be stored on or transmitted over as one or more instructions or code on a computer-readable medium. Computer-readable media include both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the disclosure should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting.

As will be appreciated from the above discussion, an advantage of the systems and methods of this disclosure includes a consensus-based transition of a blockchain from one state to another state, wherein each state may comprise one of: a public state, a private state, an open state and a permissioned state.

What is claimed is:

1. A method for a transition of a blockchain from a permissioned state to an open state, comprising:
publishing a proposal on the blockchain by an administrator to transition the blockchain from the permissioned state to the open state;
publishing on the blockchain, by zero or more further administrators, an endorsement of the proposal; and
when a predetermined number of endorsements have been published, transitioning the blockchain from the permissioned state to the open state.

2. The method of claim 1, wherein the predetermined number comprises a fraction of a total number of administrators on the blockchain.

3. The method of claim 1, wherein the proposal comprises a selection of a consensus system for the open state.

4. The method of claim 3, wherein the consensus system comprises one or more of: a proof of work, a proof of stake, a delegated proof of stake, a proof of importance, and/or a proof of authority.

5. The method of claim 1, wherein the proposal comprises a proposed block height at which the transition occurs.

6. The method of claim 5, further comprising: rejecting, by participants on the blockchain, any blocks submitted to the blockchain that do not comply with the consensus system after the proposed block height is reached.

7. A method for a transition of a blockchain from an open state to a permissioned state, comprising:
publishing a proposal on the blockchain by a participant to transition the blockchain from the open state to the permissioned state;
publishing on the blockchain, by zero or more further participants, an endorsement of the proposal; and
when a predetermined number of endorsements have been published, transitioning the blockchain from the open state to the permissioned state.

8. The method of claim 7, wherein the proposal and/or the endorsement comprise a transaction of one or more of: a cryptocurrency burning, evidence of ownership of a quantity of cryptocurrency, a cryptocurrency locking transaction, and/or a cryptocurrency transfer transaction.

9. The method of claim 7, wherein the proposal comprises a proposed block height at which the transition occurs.

10. The method of claim 8, wherein each of the zero or more further participants on the blockchain publishing endorsements is granted administrator rights if an amount of cryptocurrency referenced in the transaction is above a predetermined amount.

11. The method of claim 10, wherein administrator rights comprise one or more of: a right to publish transactions, a right to receive transactions, a right to mine data blocks, and/or a right to grant administrator rights to other participants.

12. The method of claim 11, wherein participants without administrator rights are prohibited from one or more of: publishing transactions, receiving transactions, mining data blocks, and/or granting administrator rights to other participants once the blockchain is in the permissioned state.

13. A plurality of network connected devices possessing administrator rights on a blockchain, each comprising: one or more processors and storage media comprising computer instructions, said plurality of network connected devices being connected via a peer-to-peer network to each other, arranged such that, when the computer instructions are executed on the one or more processors of one or more of the plurality of network connected devices, operations are caused for a transition of the blockchain from a permissioned state to an open state, comprising:
publishing, by a first of the plurality of network connected devices, a proposal on the blockchain to transition the blockchain from the permissioned state to the open state;
publishing, by zero or more of a remainder of the plurality of network connected devices, an endorsement of the proposal; and
when a predetermined number of endorsements have been published by the remainder of the plurality of network connected devices, transitioning the blockchain from the permissioned state to the open state by the plurality of network connected devices.

14. The plurality of network connected devices of claim 13, wherein the predetermined number comprises a fraction of a total number of the plurality of network connected devices.

15. The plurality of network connected devices of claim 13, wherein the proposal comprises a selection of a consensus system for the open state.

16. The plurality of network connected devices of claim 15, wherein the consensus system comprises one or more of: a proof of work, a proof of stake, a delegated proof of stake, a proof of importance, and/or a proof of authority.

17. The plurality of network connected devices of claim 13, wherein the proposal comprises a proposed block height at which the transition occurs.

18. The plurality of network connected devices of claim 17, further comprising: rejecting, by the plurality of network connected devices, any blocks submitted to the blockchain that do not comply with the consensus system after the proposed block height is reached.

19. A plurality of network connected devices participating on a blockchain, each comprising: one or more processors and storage media comprising computer instructions, said plurality of network connected devices being connected via a peer-to-peer network to each other, arranged such that, when the computer instructions are executed on the one or more processors of one or more of the plurality of network connected devices, operations are caused for a transition of the blockchain from an open state to a permissioned state, comprising:
publishing, by a first of the plurality of network connected devices, a proposal on the blockchain to transition the blockchain from the open state to the permissioned state;
publishing on the blockchain, by zero or more of a remainder of the plurality of network connected devices, an endorsement of the proposal; and
when a predetermined number of endorsements have been published, transitioning the blockchain from the open state to the permissioned state by the plurality of network connected devices.

20. The plurality of network connected devices of claim 19, wherein the proposal and/or the endorsement comprise a transaction of one or more of: a cryptocurrency burning, evidence of ownership of a quantity of cryptocurrency, a cryptocurrency locking transaction, and/or a cryptocurrency transfer transaction.

21. The plurality of network connected devices of claim 19, wherein the proposal comprises a proposed block height at which transitioning occurs.

22. The plurality of network connected devices of claim 20, wherein the first of the network connected devices and the zero or more of the remainder of plurality of network connected devices are granted administrator rights if an amount of cryptocurrency referenced in the transaction is above a predetermined amount.

23. The plurality of network connected devices of claim 22, wherein administrator rights comprise one or more of: a right to publish transactions, a right to receive transactions, a right to mine data blocks, and/or a right to grant administrator rights to other participants.

24. The plurality of network connected devices of claim 22, wherein network connected devices without administrator rights are prohibited from one or more of: publishing transactions, receiving transactions, mining data blocks, and/or granting administrator rights to other participants once the blockchain is in the permissioned state.
